(19) United States
(12) Patent Application Publication
(10) Pub. No.: US 2007/0257563 A1
(43) Pub. Date: Nov. 8, 2007

(54) Heat Dissipating Arrangement for a Linear Motor

(76) Inventors: Lieh-Feng Huang, Taichung Industrial Park (TW); Chia-Ming Chang, Taichung Industrial Park (TW)

Correspondence Address: BANGER SHIA, 204 CANYON CREEK, VICTORIA, TX, 77901, US

(21) Appl. No.: 11/382,020

(22) Filed: May 6, 2006

(51) Int. Cl. H02K 41/00

(52) U.S. Cl. 310/12

(57) ABSTRACT

A heat dissipating arrangement for a linear motor comprises: a stator having a predetermined length for forming a travel length, and a mover. A plurality of magnets is arranged in pairs on two opposite internal sides of the stator. The mover includes an upper positioning seat, a lower positioning seat, a heat-dissipating structure is connected between the upper and lower seats, and a plurality of coils is fixed at both sides of the heat dissipating structure.

### BACKGROUND OF THE INVENTION

1. Field of the Invention

The present invention relates to a linear motor, and more particularly to a heat dissipating arrangement for a linear motor, which has a good heat dissipating effect and can increase the current and the propelling power of the linear motor.

2. Description of the Prior Art

The existing heat dissipating methods generally include air cooling, water cooling, exterior heat sink, cooling fan, or the like. For example, the water cooling method is disclosed in U.S. Pat. No. 5,783,877, the air cooling method is mentioned in U.S. Pat. Nos. 6,469,406 and 6,717,295, the heat sink is disclosed by U.S. Pat. No. 6,300,691, and the cooling fan is disclosed in the U.S. Pat. No. 6,472,779.

However, all the abovementioned heat dissipation methods have the same disadvantages: slow heat dissipation, heat source can't be removed effectively, wasting a lot of effective power, as a result, it is impossible to improve the continuous current of the linear motor and to increase the propelling force thereof.

To solve the aforementioned problems, the inventor of this invention, based on his many years of experiences and skills in the linear transmission field, develops a brand new heat dissipating structure for a linear motor.

### SUMMARY OF THE INVENTION

The primary objective of the present invention is to provide a heat dissipating arrangement for a linear motor, which can increase the current and the propelling power of the linear motor.

A heat dissipating arrangement for a linear motor in accordance with the present invention comprises:

a stator has a predetermined length for forming a travel length, a plurality of magnets are arranged in pairs on two opposite internal sides of the stator. A mover includes an upper positioning seat, a lower positioning seat, a heat-dissipating structure is connected between the upper and lower seats, and a plurality of coils is fixed at both sides of the heat dissipating structure.

### BRIEF DESCRIPTION OF THE DRAWINGS

FIG. 1 is an exploded view of showing a heat dissipating arrangement for a linear motor in accordance with the present invention;

FIG. 2 is an assembly view of showing the heat dissipating arrangement for a linear motor in accordance with the present invention;

FIG. 3 is a cross sectional view of showing the heat dissipating arrangement for a linear motor in accordance with the present invention;

FIG. 4 is an illustrative view of a heat dissipating structure in accordance with the present invention; and

FIG. 5 is an operational view of showing the heat dissipating arrangement for a linear motor in accordance with the present invention.

### DETAILED DESCRIPTION OF THE PREFERRED EMBODIMENT

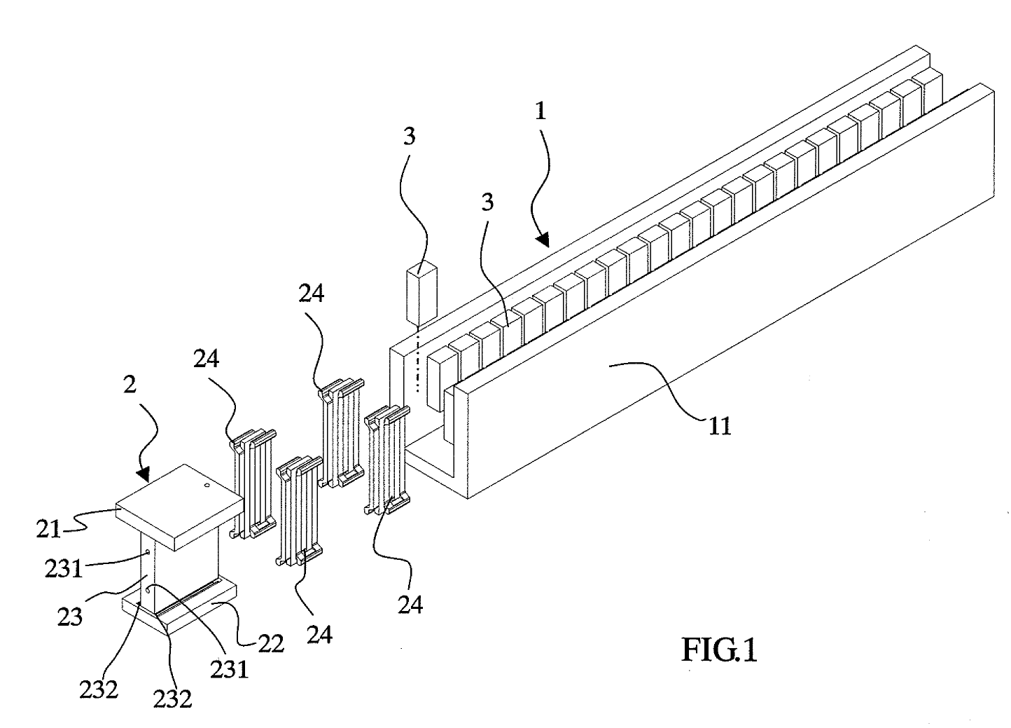

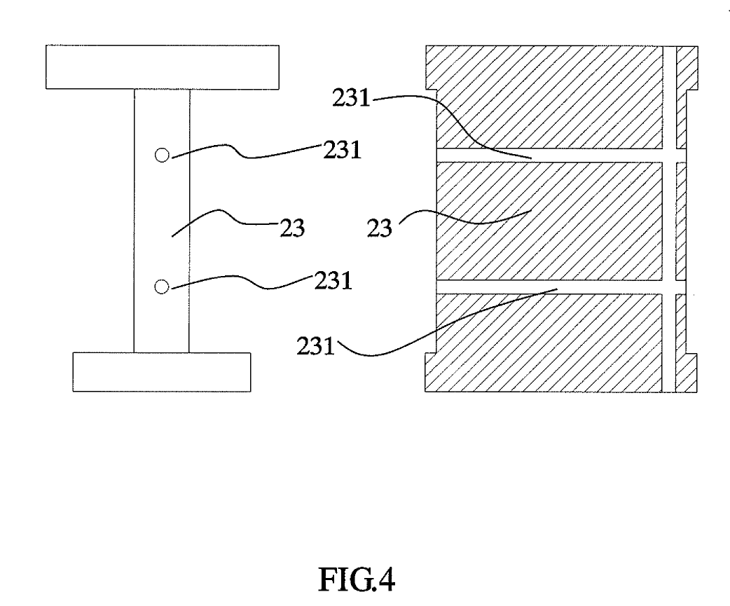

The foregoing, and additional objects, features and advantages of the present invention will become apparent from the following detailed description of preferred embodiment thereof, taken in conjunction with the accompanying FIGS. 1-5.

Referring first to FIG. 1, which is an exploded view of showing a heat dissipating arrangement for a linear motor. The heat dissipating structure for a linear motor comprises: a stator 1 and a mover 2. The stator 1 is U-shaped in cross section and has a predetermined length so as to provide a travel path. A plurality of magnets 3 is arranged in pairs on two opposite internal sides of the stator 1 and forms a passage therebetween.

The mover 2 includes an upper positioning seat 21, a lower positioning seat 22, a heat-dissipating structure 23 vertically connected between the upper and lower seats 21 and 22, and a plurality of coils 24 fixed at both sides of the heat dissipating structure 23. A water circulation path 231 is formed in the heat dissipating structure 23 for dissipating heat from the coils 24. Furthermore, an engaging groove 232 of a predetermined depth is formed in each long connecting portion between the heat dissipating structure 23 and the upper and lower seats 21, 22 for insertion of the both ends of the respective coils 24. This design can provide an improved positioning effect although the coils 24 still need to be coated with adhesive agent for the positioning purpose.

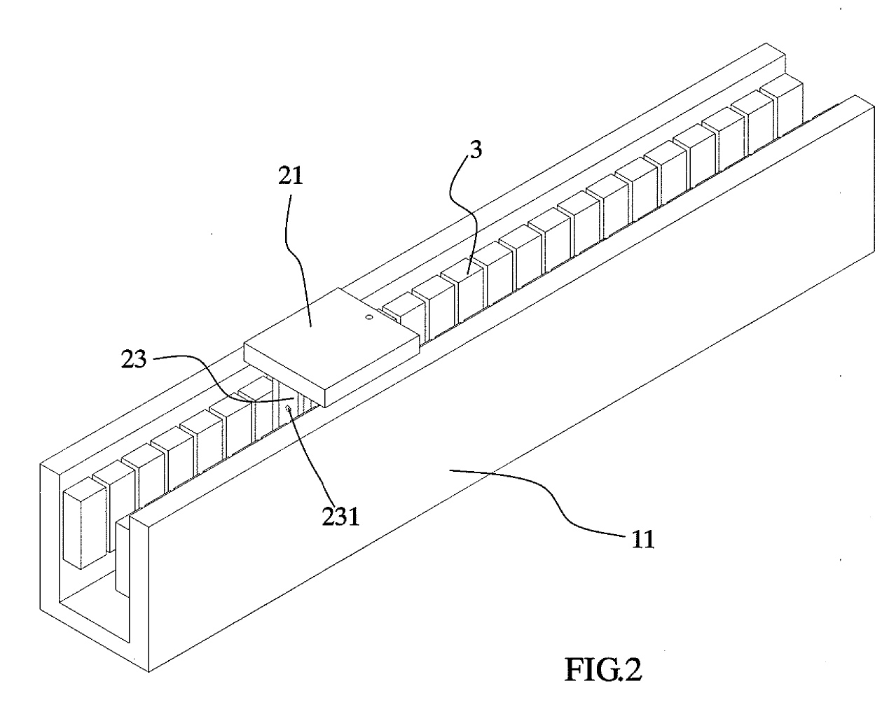

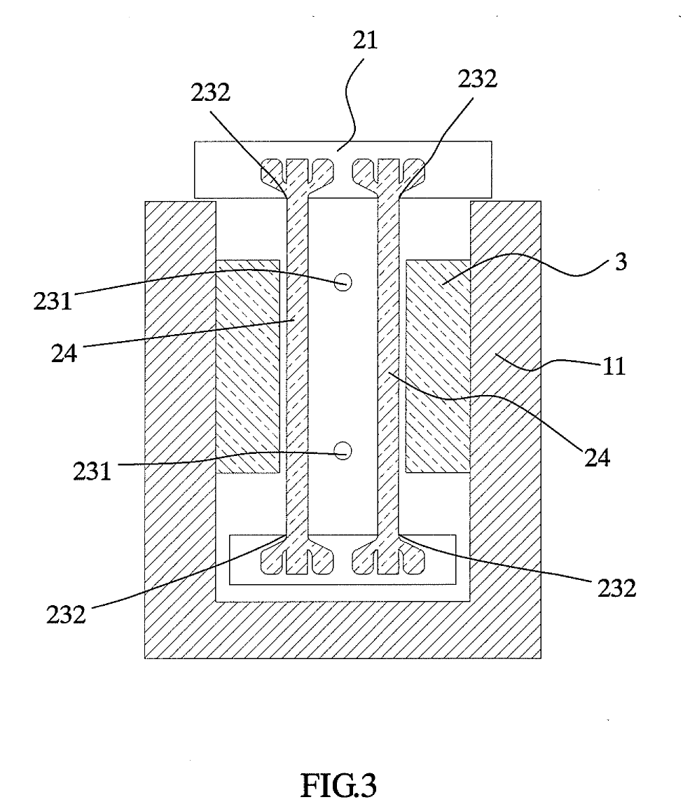

In assembly, with reference to FIGS. 2 and 3, the U-shaped body 11 of the stator 1 can be integrally formed or can be consisted of three separate parts, and this is not the key point of the present invention, so further descriptions are omitted. After forming the body 11 of the stator 1, the magnets 3 are then disposed in pairs on the opposite internal surfaces of the stator 1, and the numbers of magnets 3 on two opposite sides are equal, the purpose of arranging the magnets 3 in pairs is to create a magnetic field. The mover 2 is I-shaped in cross section. The coils 24 are inserted in the engaging grooves 232 of the upper and lower seats 21 and 22. The outer periphery of the coils 24 can be coated with adhesive agent or glass fiber plates for improving the positioning effect thereof.

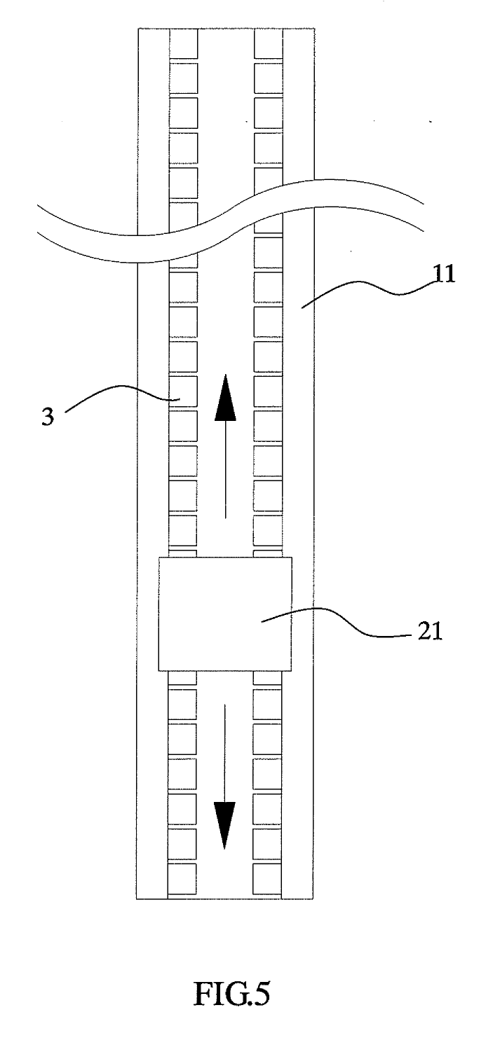

In operation, as shown in FIG. 5, and taken in accordance with the previous figures, when the mover 2 carrying predetermined equipment moves along the stator 1, since the coils 24 are located at both sides of the heat dissipating structure 23, the heat source caused during operation will adversely affect the service life and work efficiency of the linear motor. With water circulating within the water circulation path 231, the heat dissipating structure 23 can effectively take the heat source away, providing a good heat dissipating effect.

It is to be noted that the number of the water circulation path 231 can be varied according to the specification of the linear motor.

To summarize, the present invention has the following advantages:

First, the heat dissipating structure of the present invention can dissipate the heat away effectively, the current of the motor can be increased more than double, and as a result, the propelling power of the motor also increases more than double. Therefore, the resultant driving efficiency is increased substantially.

Second, when the motor is in operation, the heat dissipating structure of the present invention can effectively prevent the high-temperature caused deformation of the mover, so that the mover is prevented from rubbing against the stator and causing failure of the motor.

Third, it is economical since the number of the water circulation path can be varied according to the specification of the linear motor.

Fourth, if the heat dissipating structure is made aluminum, the movement of the linear motor can produce an eddy current and cause magnetic linkage with respect to the stator, and this is called the “damping phenomenon” of the motor. This phenomenon can make the characteristic of the motor be more close to perfect.

While we have shown and described various embodiments in accordance with the present invention, it is clear to those skilled in the art that further embodiments may be made without departing from the scope of the present invention.

What is claimed is:

1. A heat dissipating arrangement for a linear motor comprising:
a stator having a predetermined length for forming a travel length, a plurality of magnets arranged in pairs on two opposite internal sides of the stator;
a mover including an upper positioning seat, a lower positioning seat, a heat-dissipating structure connected between the upper and lower seats, and a plurality of coils fixed at both sides of the heat dissipating structure.

2. The heat dissipating arrangement for a linear motor as claimed in claim 1, wherein the heat dissipating structure is vertical to the upper and lower seats, and a plurality of water circulation paths is formed in the heat dissipating structure for dissipating heat from the coils.

3. The heat dissipating arrangement for a linear motor as claimed in claim 1, wherein an engaging groove in each long connection portion between the heat dissipating structure and the upper and lower seats for insertion of the both ends of the respective coils.

4. The heat dissipating arrangement for a linear motor as claimed in claim 1, wherein the number of the water circulation path varies according to the specification of the linear motor.
